(19) United States
(12) Patent Application Publication
(10) Pub. No.: US 2026/0329050 A1
(43) Pub. Date: Oct. 22, 2026

(54) AUTOMATIC ADJUSTMENT METHOD AND PROJECTOR THEREOF

(71) Applicant: QISDA CORPORATION, Taoyuan City (TW)

(72) Inventors: Chung-Hao Huang, Taichung City (TW); Hsin-Liang Chen, New Taipei City (TW); Sheng-Wen Hu, Taoyuan City (TW)

(73) Assignee: QISDA CORPORATION, Taoyuan City (TW)

(21) Appl. No.: 19/467,820

(22) Filed: Feb. 3, 2026

(30) Foreign Application Priority Data
Feb. 26, 2025 (CN) 202510216809.6

(51) Int. Cl. G02B 7/09; G03B 21/14

(52) U.S. Cl. CPC G02B 7/09; G03B 21/142

(57) ABSTRACT

An automatic adjustment method is applied to a projector with a motor and an operation processor. The automatic adjustment method includes acquiring a first pulse frequency of the motor, driving the motor at a second pulse frequency lower than the first pulse frequency, and increasing a drive parameter of the motor to switch the motor to the first pulse frequency when the motor is operated at the second pulse frequency for a preset period.

### BACKGROUND OF THE INVENTION

### 1. FIELD OF THE INVENTION

The present invention relates to an automatic adjustment method and a projector, and more particularly, to an automatic adjustment method of avoiding the projection image from shaking and a related projector.

### 2. DESCRIPTION OF THE PRIOR ART

With the advanced technology, the projector has more automated functions, such as horizontal correction and/or an autofocus function, and can generate the pulse signal to control the rotation angle and the rotation speed of the projection lens. In order to meet the requirement of lightweight design, the conventional projector uses the small motor to control the rotation angle and the rotation speed of the projection lens; however, the vibration of the small motor is increased significantly due to the requirement of high torque output, and the projection image output by the conventional projector may be affected and shook greatly, thereby reducing the viewing quality. Thus, design of an automatic adjustment method and a related projector that can avoid the projection image from shaking is an important issue in the related projector industry.

### SUMMARY OF THE INVENTION

The present invention provides an automatic adjustment method of avoiding the projection image from shaking and a related projector for solving above drawbacks.

According to one embodiment, an automatic adjustment method is applied to a projector having a motor and an operation processor and includes acquiring a first pulse frequency of the motor, driving the motor at a second pulse frequency lower than the first pulse frequency, and increasing a drive parameter of the motor to switch the motor to the first pulse frequency when the motor is operated at the second pulse frequency for a preset period.

According to another embodiment, a projector includes a lens module, a motor and an operation processor. The motor is attached to the lens module and adapted to control focus operation and/or zoom operation of the lens module. The operation processor is electrically connected with the motor, and adapted to acquire a first pulse frequency of the motor, drive the motor at a second pulse frequency lower than the first pulse frequency, and increase a drive parameter of the motor to switch the motor to the first pulse frequency when the motor is operated at the second pulse frequency for a preset period.

The automatic adjustment method of the present application can be preferably applied for the projector with the small motor, and the motor weight can be optionally between 15 and 25 grams. The automatic adjustment method and the projector of the present application can drive the motor at the lower pulse frequency for a short time, and the motor can operate the gear assembly at the low speed to control the focus operation and/or the zoom operation of the lens module, so as to effectively reduce the impulse generated by collision between the driving wheel and the driven wheel of the gear assembly, thereby preventing the projection image from shaking. Further, the present application can ensure that the automatic adjustment method has short operation time, and the projector can adjust the pulse frequency or the rotation speed of the motor in multiple stages during each focus operation or each zoom operation, so as to continuously output the smooth and non-shaking projection image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a projector according to an embodiment of the present application.

FIG. 2 is a diagram of a part of the projector according to the embodiment of the present application.

FIG. 3 is an enlarged diagram of another part of the projector according to the embodiment of the present application.

FIG. 4 is a flow chart of the automatic adjustment method according to a first embodiment of the present application.

FIG. 5 is a diagram of showing speed variation of the gear assembly according to the first embodiment of the present application.

FIG. 6 is a flow chart of the automatic adjustment method according to a second embodiment of the present application.

FIG. 7 is a diagram of showing the speed variation of the gear assembly according to the second embodiment of the present application.

FIG. 8 is a flow chart of the automatic adjustment method according to a third embodiment of the present application.

FIG. 9 is a diagram of showing the speed variation of the gear assembly according to the third embodiment of the present application.

### DETAILED DESCRIPTION

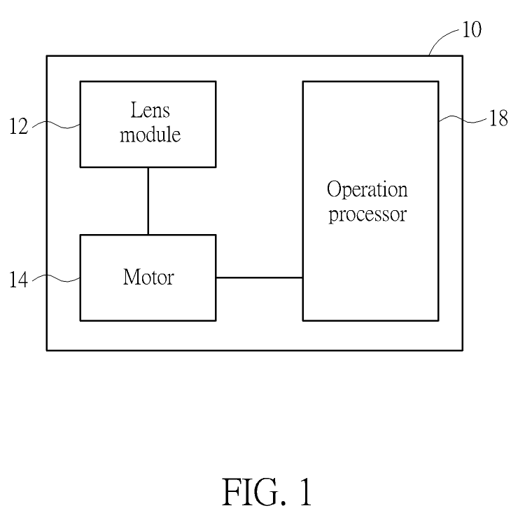

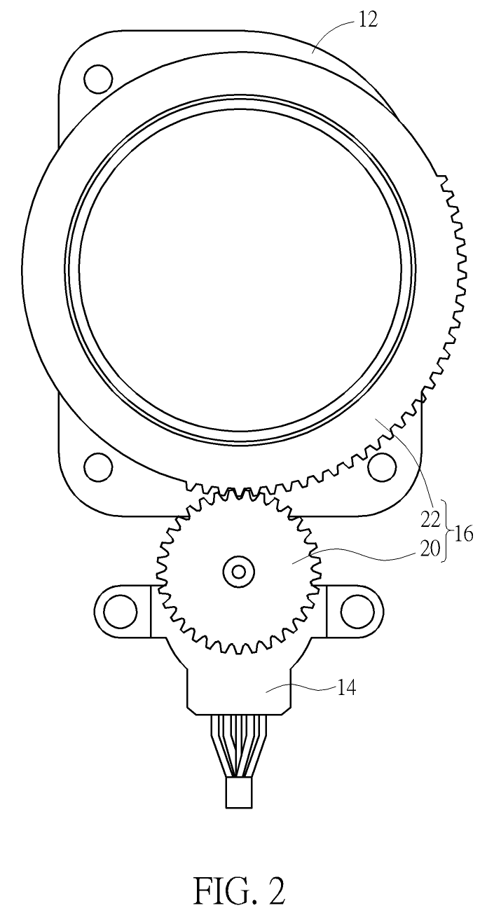

Please refer to FIGS. 1 and 2. FIG. 1 is a functional block diagram of a projector 10 according to an embodiment of the present application. FIG. 2 is a diagram of a part of the projector 10 according to the embodiment of the present application. The projector 10 can include a lens module 12, a motor 14, a gear assembly 16 and an operation processor 18. The lens module 12 can output a projection image. The lens module 12 can include multiple optical components and multiple electronic components, such as the lens and the light source, and a detailed description is omitted herein for simplicity. The motor 14 can be attached to the lens module 12 via the gear assembly 16, and used to control focus operation and/or zoom operation of the lens module 12. The motor 14 can be a stepper motor, but the actual application is not limited thereto. The operation processor 18 can be electrically connected with the motor 14 and used to execute an automatic adjustment method of the present application.

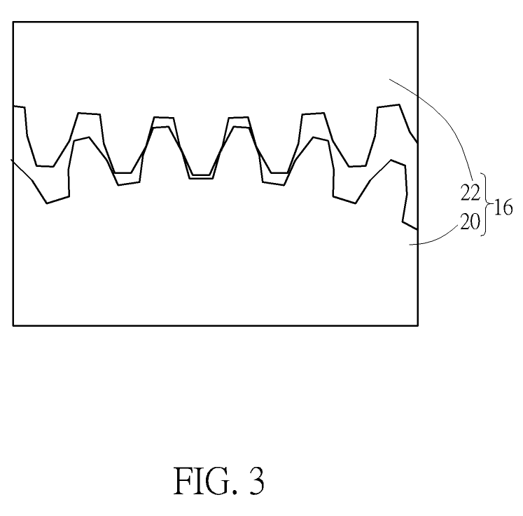

Please refer to FIG. 3. FIG. 3 is an enlarged diagram of another part of the projector 10 according to the embodiment of the present application. The gear assembly 16 can optionally include at least a driving wheel 20 and a driven wheel 22. Types of the driving wheel 20 and the driven wheel 22 are not limited to the embodiment shown in FIGS. 2 and 3, and depend on a design demand. For assembly convenience, there must be backlash between the driving wheel 20 and the driven wheel 22 when the driving wheel 20 is assembled with the driven wheel 22 to form the gear assembly 16. The assembly process of installing the gear assembly 16 between the lens module 12 and the motor 14 may produce cumulative tolerance. As the motor 14 drives the lens module 12 to rotate at different directions, an idle stroke between the driving wheel 20 and the driven wheel 22 may generate an impulse and cause the projection image to shake, so that the operation processor 18 can execute the automatic adjustment method of the present application to maintain stability of the projection image.

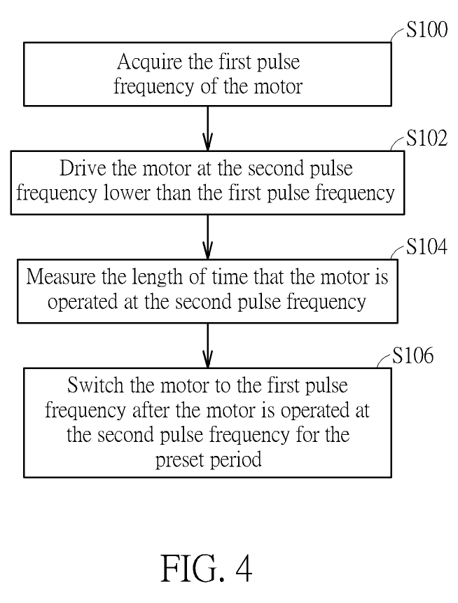

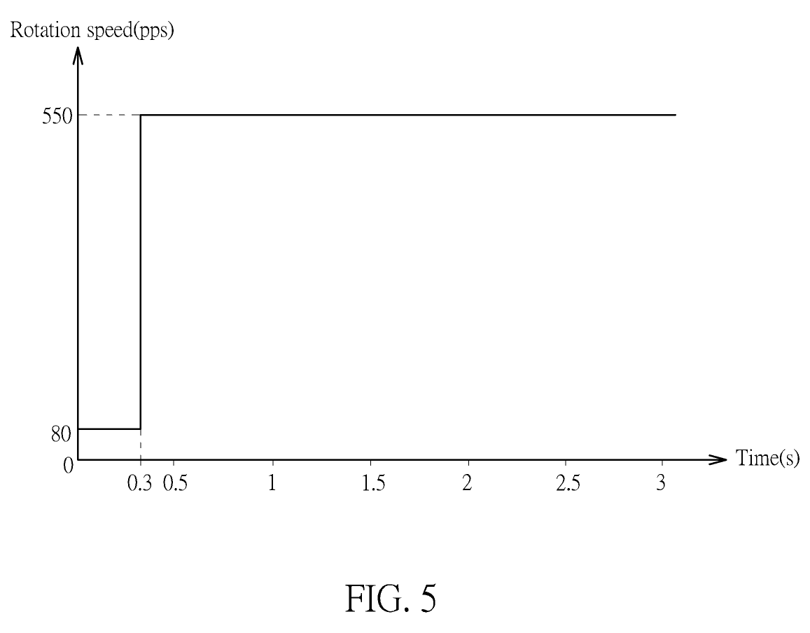

Please refer to FIGS. 4 and 5. FIG. 4 is a flow chart of the automatic adjustment method according to a first embodiment of the present application. FIG. 5 is a diagram of showing speed variation of the gear assembly 16 according to the first embodiment of the present application. First, step S100 and step S102 can be executed that the operation processor 18 can acquire a first pulse frequency of the motor 14, and drive the motor 14 at a second pulse frequency that is lower than the first pulse frequency. In the embodiment, the first pulse frequency can be preferably defined as a maximum pulse frequency of the motor 14, and the second pulse frequency can be accordingly defined as being between fifty and eighty pulses per second; variation of the first pulse frequency and the second pulse frequency can depend on the design demand. Then, step S104 and step S106 can be executed to measure a length of time that the motor 14 is operated at the second pulse frequency, and increase the drive parameter of the motor 14 to switch the motor 14 to the first pulse frequency when/after the motor 14 is operated at the second pulse frequency for a preset period.

The preset period can be set as being less than one-half second, but the actual application is not limited thereto. In the first embodiment, the operation processor 18 can utilize the lower second pulse frequency to drive the motor 14 for the preset period, and this process can allow the driving wheel 20 to contact the driven wheel 22 with a slight force. When the driving wheel 20 actually contacts the driven wheel 22, the motor 14 can be adjusted to drive at the first pulse frequency, and can perform the focus operation and/or the zoom operation of the lens module 12 via the gear assembly 16. It should be mentioned that the present application can preferably use a fixture to measure the idle stroke of the gear assembly 16, and compute a corresponding pulse number for deciding a value of the second pulse frequency. Therefore, the projector 10 can reduce or eliminate collision impulse in the gear assembly 16 by executing the automatic adjustment method of the present application, thereby maintaining the stability of the projection image.

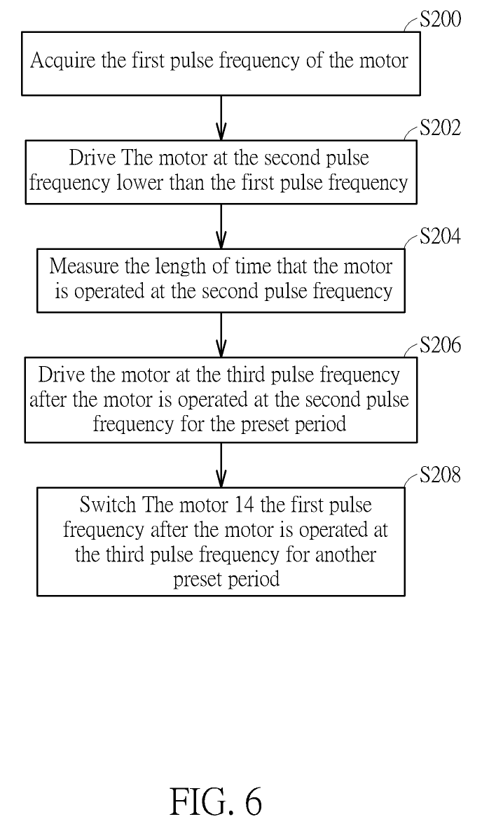

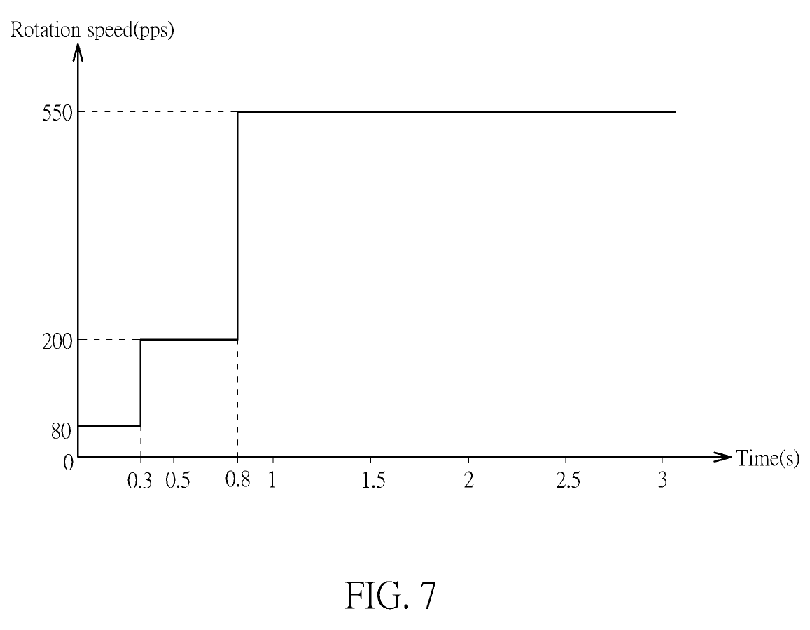

Please refer to FIGS. 6 and 7. FIG. 6 is a flow chart of the automatic adjustment method according to a second embodiment of the present application. FIG. 7 is a diagram of showing the speed variation of the gear assembly 16 according to the second embodiment of the present application. First, step S200 and step S202 can be executed that the operation processor 18 can acquire the first pulse frequency of the motor 14, and drive the motor 14 at the second pulse frequency lower than the first pulse frequency. Then, step S204 and step S206 can be executed to measure the length of time that the motor 14 is operated at the second pulse frequency, and drive the motor 14 at a third pulse frequency when/after the motor 14 is operated at the second pulse frequency for the preset period. The third pulse frequency can be lower than the first pulse frequency but greater than the second pulse frequency. For example, the third pulse frequency can be set as two hundred pulses, or can be set between one third and one half of the first pulse frequency, or a difference between the second pulse frequency and the third pulse frequency can be less than two hundred and fifty pulses per second. Variation of the third pulse frequency can depend on the design demand. Final, step S208 can be executed to increase the drive parameter of the motor 14 to switch the motor 14 to the first pulse frequency when/after the motor 14 is operated at the third pulse frequency for another preset period.

The foresaid another preset period can be set to be less than one second or 0.8 seconds, but the actual application is not limited thereto. In the second embodiment, the operation processor 18 can utilize the lower second pulse frequency to drive the motor 14 for the preset period, and this process can allow the driving wheel 20 to be close to or contact the driven wheel 22 with the slight force. When the driving wheel 20 actually contacts or is close to the driven wheel 22, the motor 14 can be adjusted to drive at the third pulse frequency, and the driving wheel 20 can slightly contact or push the driven wheel 22. Then, the motor 14 can be adjusted to drive at the first pulse frequency, and perform the focus operation and/or the zoom operation of the lens module 12 via the gear assembly 16. The projector 10 can reduce or eliminate the collision impulse in the gear assembly 16 more effectively by executing the automatic adjustment method of the present application.

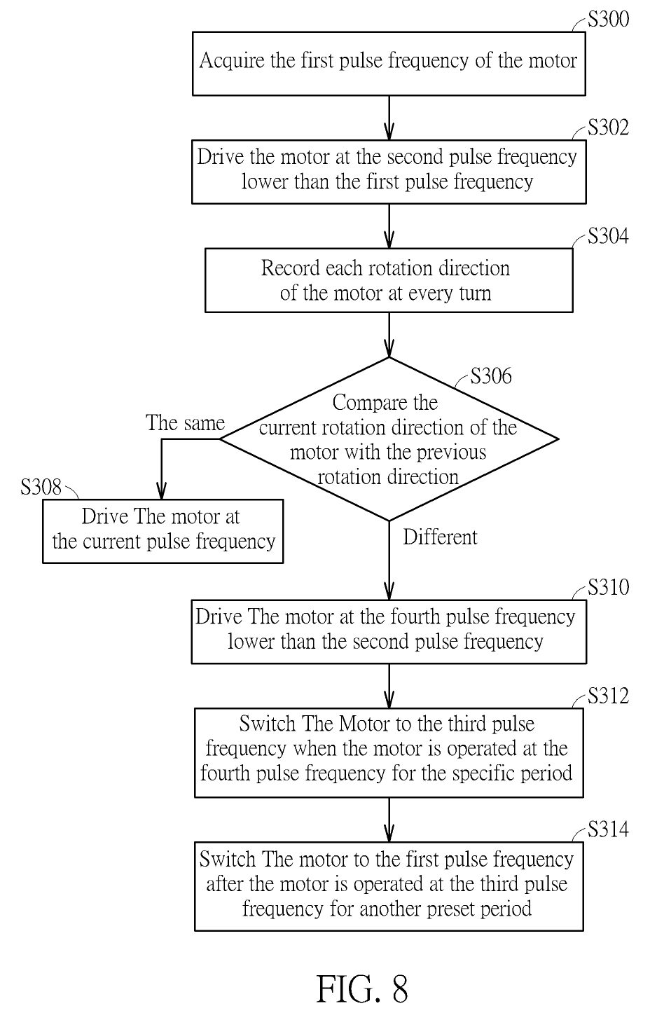

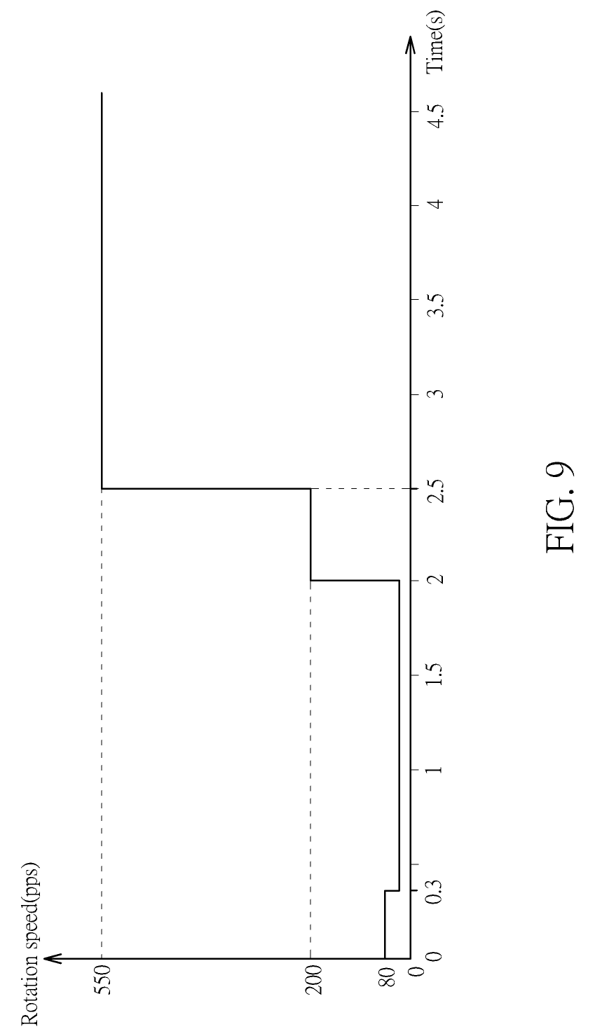

Please refer to FIGS. 8 and 9. FIG. 8 is a flow chart of the automatic adjustment method according to a third embodiment of the present application. FIG. 9 is a diagram of showing the speed variation of the gear assembly 16 according to the third embodiment of the present application. First, step S300 and step S302 can be executed that the operation processor 18 can acquire the first pulse frequency of the motor 14, and drive the motor 14 at the second pulse frequency lower than the first pulse frequency. Then, step S304 and step S306 can be executed to record each rotation direction of the motor 14 at every turn, and compare a current rotation direction of the motor 14 with a previous rotation direction. If the current rotation direction is the same as the previous rotation direction, it means that the gear assembly 16 can maintain positive rotation and there should be no backlash between the two gears, and step S308 can be executed to drive the motor 14 at the current pulse frequency. If the current rotation direction is different from the previous rotation direction, it means that the gear assembly 16 can perform reverse rotation and there should be the backlash between the two gears, and step S310 can be executed to drive the motor 14 at a fourth pulse frequency that lower than the second pulse frequency. The fourth pulse frequency can be defined as a minimum pulse frequency of the motor 14, such as twenty pulses per second, and its variation can depend on the design demand.

Then, step S312 and step S314 can be executed to increase the drive parameter of the motor 14 to switch the motor 14 to the third pulse frequency when the motor 14 is operated at the fourth pulse frequency for a specific period (such as two seconds), and increase the drive parameter of the motor 14 to switch the motor 14 to the first pulse frequency when/after the motor 14 is operated at the third pulse frequency for another preset period. To ensure that each pair of teeth (e.g., a certain tooth of the driving wheel 20 and the corresponding tooth of the driven wheel 22) of the gear assembly 16 can be contacted to each other at the same speed when the wheels of the gear assembly 16 are rotated in opposite directions, the third embodiment can determine whether the wheels of the gear assembly 16 are rotated in the reverse directions, and drive the gear assembly 16 at the minimum rotation speed (which corresponds to the minimum pulse frequency of the motor 14) to reduce or eliminate the collision impulse in the gear assembly 16 when the wheels of the gear assembly 16 are rotated in the reverse directions. Subsequently, the rotation speed can be gradually increased in a slow acceleration manner (which corresponds to variation in the pulse frequency of the motor 14). Generally, the present application can preferably change the drive parameter of the motor 14 to increase its pulse frequency in a manner of increasing a number of pulses per second by less than 500, but the actual application is not limited to this.

In conclusion, the automatic adjustment method of the present application can be preferably applied for the projector with the small motor, and the motor weight can be optionally between 15 and 25 grams. The automatic adjustment method and the projector of the present application can drive the motor at the lower pulse frequency for a short time, and the motor can operate the gear assembly at the low speed to control the focus operation and/or the zoom operation of the lens module, so as to effectively reduce the impulse generated by collision between the driving wheel and the driven wheel of the gear assembly, thereby preventing the projection image from shaking. Further, the present application can ensure that the automatic adjustment method has short operation time, and the projector can adjust the pulse frequency or the rotation speed of the motor in multiple stages during each focus operation or each zoom operation, so as to continuously output the smooth and non-shaking projection image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automatic adjustment method applied to a projector having a motor and an operation processor, the automatic adjustment comprising:
the operation processor acquiring a first pulse frequency of the motor;
the operation processor driving the motor at a second pulse frequency lower than the first pulse frequency; and
the operation processor increasing a drive parameter of the motor to switch the motor to the first pulse frequency when the motor is operated at the second pulse frequency for a preset period.

2. The automatic adjustment method of claim 1, further comprising:
the operation processor driving the motor at the first pulse frequency when the motor is operated at the second pulse frequency for the preset period.

3. The automatic adjustment method of claim 1, further comprising:
the operation processor driving the motor at a third pulse frequency that is lower than the first pulse frequency but greater than the second pulse frequency when the motor is operated at the second pulse frequency for the preset period;
wherein the operation processor increases the drive parameter of the motor to switch the motor to the first pulse frequency when the motor is operated at the third pulse frequency for another preset period.

4. The automatic adjustment method of claim 1, further comprising:
the operation processor increasing the drive parameter of the motor from the second pulse frequency to the first pulse frequency in a manner of increasing a number of pulses per second by less than 500.

5. The automatic adjustment method of claim 1, wherein the first pulse frequency is a maximum pulse frequency of the motor, the second pulse frequency is between fifty and eighty pulses per second, and the preset period is less than one-half second.

6. The automatic adjustment method of claim 3, wherein the third pulse frequency is between one third and one half of the first pulse frequency.

7. The automatic adjustment method of claim 3, wherein a difference between the second pulse frequency and the third pulse frequency is smaller than two hundred and fifty pulses per second.

8. The automatic adjustment method of claim 1, further comprising:
the operation processor recording each rotation direction of the motor at every turn; and
the operation processor driving the motor at a fourth pulse frequency lower than the second pulse frequency when determining a current rotation direction of the motor is different from a previous rotation direction.

9. The automatic adjustment method of claim 8, wherein the fourth pulse frequency is a minimum pulse frequency of the motor, and the operation processor drives the motor at the second pulse frequency and the minimum pulse frequency in sequence.

10. A projector comprising:
a lens module;
a motor attached to the lens module and adapted to control focus operation and/or zoom operation of the lens module; and
an operation processor electrically connected with the motor, and adapted to acquire a first pulse frequency of the motor, drive the motor at a second pulse frequency lower than the first pulse frequency, and increase a drive parameter of the motor to switch the motor to the first pulse frequency when the motor is operated at the second pulse frequency for a preset period.

11. The projector of claim 10, wherein the operation processor is adapted to further drive the motor at the first pulse frequency when the motor is operated at the second pulse frequency for the preset period.

12. The projector of claim 10, wherein the operation processor is adapted to further drive the motor at a third pulse frequency that is lower than the first pulse frequency but greater than the second pulse frequency when the motor is operated at the second pulse frequency for the preset period, the operation processor increases the drive parameter of the motor to switch the motor to the first pulse frequency when the motor is operated at the third pulse frequency for another preset period.

13. The projector of claim 10, wherein the operation processor is adapted to further increase the drive parameter of the motor from the second pulse frequency to the first pulse frequency in a manner of increasing a number of pulses per second by less than 500.

14. The projector of claim 10, wherein the first pulse frequency is a maximum pulse frequency of the motor, the second pulse frequency is between fifty and eighty pulses per second, and the preset period is less than one-half second.

15. The projector of claim 12, wherein the third pulse frequency is between one third and one half of the first pulse frequency.

16. The projector of claim 12, wherein a difference between the second pulse frequency and the third pulse frequency is smaller than two hundred and fifty pulses per second.

17. The projector of claim 10, wherein the operation processor is adapted to further record each rotation direction of the motor at every turn, and drive the motor at a fourth pulse frequency lower than the second pulse frequency when determining a current rotation direction of the motor is different from a previous rotation direction.

18. The projector of claim 17, wherein the fourth pulse frequency is a minimum pulse frequency of the motor, and the operation processor drives the motor at the second pulse frequency and the minimum pulse frequency in sequence.
